(19) United States
(12) Patent Application Publication
(10) Pub. No.: US 2004/0169722 A1
(43) Pub. Date: Sep. 2, 2004

(54) Method and system for computer-aided telecommunication and financial transactions

(76) Inventor: Martin Rangel Pena, Charlotte, NC (US)

Correspondence Address: DOROTHY J. MORSE, ESQ., 515 PARK DRIVE, NW, BRADENTON, FL, 34209-1847, US

(21) Appl. No.: 10/798,515

(22) Filed: Mar. 9, 2004

Related U.S. Application Data
(63) Continuation-in-part of application No. 09/954,803, filed on Sep. 18, 2001, now Pat. No. 6,704,039.
Application No. 09/954,803 is a continuation-in-part of application No. 09/419,729, filed on Oct. 16, 1999, now Pat. No. 6,292,211.

(51) Int. Cl. H04N 7/14; H04M 1/64

(52) U.S. Cl. 348/14.01; 348/14.08

(57) ABSTRACT

A computer-aided telecommunication system and method for communication and financial transactions which employs an on-line website to allow those skilled and unskilled in computer operation to communicate with others and conduct diverse financial transactions at any time and from any computer or electronic device adapted for access to the Internet. Subscribers and others can conduct real-time visual communication with remotely located parties, exchange still and moving images, distribute written information, make purchases, and manage accounts at a lower cost than alternative forms of communication. The system comprises a minimum of one control station and many remote e-mail/ATM stations placed in secure monitored locations. Each subscriber is assigned a unique access code and e-mail address, and undergoes identity confirmation procedures prior to system use. For ease of e-mail communication, subscribers would only need the name of an intended recipient subscriber or subscriber group identification and not individual e-mail addresses.

### CROSS-REFERENCES TO RELATED APPLICATIONS

This patent application is a continuation-in-part based upon the currently co-pending U.S. patent application Ser. No. 09/954,803 filed by the same inventor, which is a continuation-in-part of an earlier U.S. patent application Ser. No. 09/419,729 filed by the same inventor, now U.S. Pat. No. 6,292,211 to Pena (2001). Benefit of both previously filed U.S. patent applications is herein requested.

### BACKGROUND

1. Field of the Invention

This invention relates to telecommunication and money transfer systems, specifically to a computer-aided system and method for telecommunication and financial transactions which employs an on-line website and a plurality of computers to create a subscriber network for use by skilled and unskilled computer operators alike anywhere and at any time, from any computer or communication device having a keyboard, keypad, voice-activated operation, or touch screen technology including personal computers in the home and office, communication equipment located in a commercial privacy booth with or without an automated teller machine (ATM), direct telephone connection to customer service personnel, and/or pneumatic tube delivery system; self-help email stations with or without an ATM, direct telephone connection to customer service personnel, and/or pneumatic tube delivery system; remote email stations with or without an ATM or direct telephone connection to customer service personnel; money sending and receiving ATM kiosks that also can be used to pay bills, send email, purchase tickets, money orders, pre-pay phone cards, debit cards, and access to the Internet, software applications, and games, as well manage financial accounts and store or send documents and files that are too large to process via a personal computer; virtual bank teller machines; hand-held personal digital assistants; pagers; and mobile phones; as well as any other device adapted or adaptable to permit on-line access. Although the majority of users would be subscribers, non-subscribers would have a more limited selection of services available on a unit cost basis.

2. Description of the Related Art

Worldwide communication between many remotely located business associates, friends, and family members is now nearly instantaneous and relatively easy to accomplish. Also, for those having computer skills and inexpensive on-line computer access, the cost of such communication has been dramatically lowered. However, there are people who lack computer skills, those who travel frequently or become temporarily relocated for periods of time too short to establish or transfer local telephone service, and those who lack the ability to purchase the computer hardware and software necessary for on-line access, who have not been able to take advantage of this technology. These people find alternative forms of communication expensive, subject to delay, and often totally inadequate when an important letter or package is not delivered to the intended recipient in its original condition or is never delivered at all.

In addition, non-Internet communication between people in different countries can be particularly difficult. A letter traveling to someone in a remote location can take two weeks or longer for delivery. Weak law enforcement and corruption can further complicate the process and place money transfer between friends and family members in different countries at particularly high risk. For example, newspaper articles have cited the disappearance of millions of dollars sent annually by migrant workers in the United States to their families in Mexico. U.S. Postal Service money orders are used to send approximately one-third of such funds, and during the period between 1988 and 1998 claims alone for lost and stolen U.S. Postal Service money orders increased six-fold to more than $12 million. False identification is often used to divert the funds from the intended recipient. Violent gangs, as well as corrupt money exchangers, postal workers, and police, have been found responsible for perpetuating the problem. A secure means for transferring money between remotely located friends and family members, particularly when friends and family members are located in different countries, is much needed.

The present invention brings a solution to the existing problem by offering to those who may be unskilled in computer operation, or not otherwise in a position to use computer technology, a way of accessing it so as to have instant communication with remotely located friends and family members, rapid transfer of money from one to the other with potentially instant notification of transfers thus made, and also instant transfer of up-to-date still and/or moving images from one to the other at a cost that is relatively low when compared to alternative forms of communication. In the alternative, it can also provide a means for any subscriber through a personal computer at home or in the office, other personal digital device permitting on-line access, remote e-mail/ATM station including kiosk-like and wall mounted units to conduct a wide variety of purchases and other financial transactions, such as but not limited to purchase of entertainment and transportation tickets, purchase of renewable phone or smart cards, purchase of money orders, payment of bills and payrolls with email confirmation, money wiring transactions, virtual financial transactions, cash checks, and prepay access to the Internet, software applications, and games. The temporary or permanent relocation of family members sometimes places a heavy burden on those affected by the separation. Having visual contact with remote loved ones during a voice communication or for a special occasion would bring added pleasure and peace of mind to both parent, grandparent, child and/or grandchild, when each can see for themselves that the person with whom they are communicating appears to be in good health. Although visual contact could be accomplished by existing methods of videoconferencing, such methods are generally too expensive to be widely used for such non-business communication and data transfer. In addition, existing videoconferencing methods have no provision for money transfer between the participants.

Other disadvantages are also inherent in the alternative prior art methods available for communication between separated family members and friends. While written communication can be one of the least expensive options, travel delays are common in getting a recorded message to remote recipients, one must have a continually updated street or post office box address for successful delivery which is not always possible, and recorded messages are time consuming to compose. Further, letter writing is not a task enjoyed by everyone. Courier services and overnight mail can be used to help to insure more rapid and secure delivery of written communications, but at a premium cost that can make such services great for businesses but unaffordable by most individuals for routine use. Telephone communication has the advantage of being immediate, however a person long separated from his family often cannot afford the luxury of frequent videoconferencing communication and even routine long distance charges may be cost prohibitive for use as often as separated family members might like to remain in contact, particularly when international telephone calls are necessary. Other forms of communication, including the sending of audio and/or videotapes to one another, short-wave radio communication, faxing, and e-mail, all require the availability of expensive electronic equipment for both the sender and recipient. Another factor to assess in the use of electronic communication equipment is the minimum skill level required for people to operate it. There are those who are technically unskilled and would not be able to effectively use the simplest devices available for use. Further, in the alternative when unskilled senders and/or recipients rely on currently available outside technical sources for faxing, short-wave radio communication, or e-mail services, the privacy of the communication may be compromised. While an increasing number of people are becoming computer literate and starting to rely on computers for a significant part of their communication needs, there are still those without adequate computer skills who cannot take advantage of this type of communication, and those for whom family separation has imposed at least a temporary financial burden which makes the purchase or lease of computer equipment for both correspondents unfeasible. At this time there is no known communication system or method that is low in cost to the user, private, immediate, and allows the transfer of up-to-date still and moving images between correspondents.

In addition, money transfer and other financial transactions between remotely located family members and friends, or for their benefit, is often needed and poses its own set of challenges. Money exchange through the mail is slow and frequently places the money at risk for loss. Inter-bank transactions can enhance transfer security, however they can be expensive and delays in money distribution are known to occur. Money can also be wired to individuals, however, delays can be encountered when codes are forgotten and misdirection of funds has been known to happen, many times through fraud. Where family members or friends are remotely situated from one another and have the need to periodically communicate, it would be useful to have a technologically sophisticated means for combining a video-conferencing type of communication with the prompt transfer of money, and to have such communication and money transfer available without requiring any of the senders or recipients to have computer expertise or purchase expensive equipment. It would also be helpful if the same system offered those with independent computer access a means for conducting a wide variety of financial transactions. No other system and method are known that functions in the same manner or provides all of the advantages of the present invention.

### BRIEF SUMMARY OF THE INVENTION

It is the primary object of this invention to provide a computer-aided system and method which can be used by separated family members and others, whether computer literate or note to visually communicate with one another, transfer money from one to the other, transfer up-to-date still and moving pictures between them, and conduct a variety of financial transactions without having to purchase expensive computer and/or other electronic equipment to do so. It is also an object of this invention to provide a computer-aided communication system and method that will let a person who is not necessarily computer literate to send and receive confidential e-mail messages. A further object of this invention is to provide a computer-aided communication system and method which can provide telecommunication, money transfer, an opportunity for conducting financial transactions, and transfer of up-to-date still and moving images at a cost to the user that is lower than that of prior art telecommunication systems. It is also an object of this invention to provide a computer-aided communication system and method that protects the privacy of all communications between users. It is a further object of this invention to provide a computer-aided communication system and method that is capable of automatically giving users a printed copy of all e-mail messages that are transmitted to them and allows them to confidentially send pre-written e-mail messages. It is also an object of this invention to provide a computer-aided communication system and method that allows a user to exchange information with all system subscribers if desired, such as information about items for sale, upcoming events, and available jobs, and for subscribers to screen such information in private. It is a further object of this invention to provide a computer-aided communication system and method that allows some transactions at remote e-mail/ATM stations by non-subscribers, and permits subscribers to communicate with and send money to non-subscribers. It is a further object of this invention to provide a computer-aided communication system and method that allows a user to conduct a diverse selection of additional services at any time through a personal computer or communication device with a keyboard, keypad, touch screen, or voice activated operation, or via remote email stations including stand-alone kiosk-like units or wall-mounted units with or without pneumatic tube delivery systems and a direct customer service assistance line connected thereto, to include but not be limited to email payroll with notification when employees gain access to transferred money; web folder space usable for personal and/or business record keeping purposes; wireless memory space for unloading digital memory space including images and videos from cameras and/or other equipment; video financial transactions; email financial transactions with notifications; multi-lingual website and customer service access; sending scanned text and images via email; virtual financial transactions wherein a temporary virtual account of indefinite duration is created for money management by a user within the present invention system; manual or automatic bill paying with notification using a variety of client resources and/or accounts accessible through the present invention system; purchase of prepaid phone cards and adding balances to telephone accounts using a variety of client resources; purchase of prepaid smart/debit cards and adding balances to existing smart card accounts using a variety of client resources; purchase of and adding balances to accounts for the automatic payment of expressway, bridge, tunnel, and other transportation tolls; cashing check; purchasing money orders with notification of the date of receipt or transfer to a virtual account; purchasing plane tickets with notifications and confirmations regarding departure date, delays, and/or cancellations; purchasing bus or rail tickets with notifications and confirmations regarding departure date, delays, and/or cancellations; purchasing entertainment tickets with notifications and confirmations regarding changes in time, postponements, and/or cancellations and advance notification about events; international and national web-voice mail for handling calls and email within the present invention system; prepaid Internet access with use only during connection to the Internet; prepaid software applications and game with use only during connection to the Internet; multi-lingual customer service in voice and full motion video; advertising in full motion video that includes safety and public information related messages; vistual video teller service that includes screens offering a choice of payment options and establishment of preferences for completion of transactions; certified email services that provide identity checks and notifications; web voice notification where users can send or elect to receive any type of notification, such as but not limited to confirmations of financial transactions, family events, business transactions, and/or package deliveries; video email to send and/or receive family messages, business communication, and other personal transactions that may or may not include money messages.

The present invention offers its users the opportunity to transfer written information, images, and money to remote subscribers and others, including the transfer of notices about events, sales, and employment opportunities directed to more than one recipient; the conduct of real-time visual communication with one another; secure money transfer between individuals; manage accounts; use web folder and personal memory space within the present invention system, use virtual video teller services, make purchases, prepay Internet access, software application and game fees only when connected to the Internet, and also optionally receive still and/or moving images of remote correspondents at a cost that is relatively low when compared to alternative forms of communication. In addition those skilled in computer operation can optionally access the established subscriber network from any personal computer or other digital device permitting on-line access, a privacy booth, a network control station, a network-connected local e-mail station, or one of many network-connected remote e-mail/ATM stations or kiosks, to accomplish a wide variety of communication and financial transactions, including but not limited to sending money to remote individuals, paying bills, cashing checks, issuing paychecks, exchanging currencies, purchasing prepaid telephone cards, purchasing prepaid debit cards, purchasing money orders, purchasing transportation or entertainment tickets, purchasing goods and services such as groceries and gas, purchasing prepaid software applications, purchasing bandwidth to send large files or for videoconferencing purposes, and pre-paying entertainment costs. Fast and private money transfer between one or more donating subscribers and one or more recipients remote from the donor, with on-camera money transfer confirmation, can take place in specially equipped privacy booths. For many transactions, neither the recipient nor the sender has to be a subscriber. Money transfer can also take place between individuals whereby money is directly deposited in a bank or credit union account of another, or the money is made available for pick up, all or part thereof, via any remote e-mail/ATM station, control station, or local e-mail station also having ATM capability. At the option of the recipient, money pick up can be in the form of cash, prepaid phone cards, prepaid debit cards, money orders, or other currency equivalent. Since personal identity confirmation is required for most transactions, personal home computer systems used for subscriber network access must have video communication equipment, such as a netcam. Stand-alone network-accessing units, such as the stand-alone kiosk-like and wall-mounted remote e-mail-ATM stations, should each have video-recording and automated teller machine capability, and would be strategically placed in secure well-lighted locations, such as but not limited to convenience stores, grocery stores, drug stores, shopping malls, hotel lobbies, restaurants, theaters, bus stations, and airports. Certain cash transactions, such as the purchase of a prepaid phone card or money order, could be completed by non-subscribers at stand-alone network accessing units. However, for a large number of transactions at least the donor would be a network subscriber. As part of the application process for becoming a network subscriber, a digital photograph of the person is taken and entered into the network's computer database, along with other identifying information about the subscriber, such as but not limited to social security number, full name, birth date, and/or full address and telephone number. Additional layers of security can also be employed as part of the application process on an as needed basis, including but not limited to the taking of one or more fingerprints and establishing voice recognition patterns. Thereafter, a subscriber wanting to perform a variety of financial transactions through use of the present invention, whether positioned in front of his or her own computer, a local e-mail station with ATM capability located at one of the network offices where privacy booths are also located, or in front of a stand-alone remote e-mail/ATM station network accessing unit, can do so by simply entering a discrete password and allowing the system to take a current digital photograph, fingerprint, and/or voice pattern sample and compare it to the digital photograph and other data already on file in its computer database. If currently collected data matches that originally collected upon registration as a subscriber, then the subscriber is permitted access to the network to accomplish any service for which pre-payment has been made. If current and original data do not match, network access is denied and compliance with further network procedures must be achieved before the person requesting network access can be permitted use of network services. When money is transferred to another person, the recipient will receive a message about the transfer via e-mail, pager, voice mail, or mobile phone, whereafter the recipient can proceed to the nearest network-accessing unit having automated teller machine capability to obtain all or part of the transferred money. If only part of the money is withdrawn from the subscriber network, the remainder can be maintained within the network indefinitely until recipient chooses to withdraw it. Further, a video screen, microphone, camera, and speaker or speakers associated with an e-mail station in a network office housing privacy booths, or as part of a stand-alone remote network-accessing unit, can further assist subscribers by providing full motion video customer service and alternatively provide the network with the opportunity for revenue generation through full motion video advertising. The simplest preferred embodiment of the subscriber system comprises two central processing units; two computer monitors; two keyboards; two printers; two printer/scanner/fax/copier combination units unless separate equipment for printing, scanning, faxing, and copying is alternatively made available for use; two video recorders; at least two privacy booths in which to conduct visual conferences, each having a high resolution monitor, a keyboard or keypad or voice activation technology or touch screen technology for monitor operation, a live video capture camera, audio speakers, at least one microphone, an optional writing surface, and at least one piece of furniture which can comfortably seat visual correspondents; and a plurality of network-accessing units each having video-recording capability that are strategically placed in secure locations to facilitate money transfer and other financial transactions. Enhancement can include but are not limited to a direct-line telephone connected to customer service personnel or a switchboard, and/or a pneumatic tube delivery system.

As described herein, the present invention would provide a computer-aided system and method for telecommunication that would allow separated people who may not have sophisticated computer skills or state-of-the-art computer equipment of their own to schedule real-time long distance visual communication with one another, to conduct such communication in private, to effect prompt and secure transfer of money from one user to another, to transfer up-to-date still and moving images between users, and conduct a variety of financial and other transactions. Those who are not subscribers could use network-connected remote e-mail/ATM stations to conduct a pre-determined number of services in exchange for a prepaid transaction fee. A more diverse selection of services would be available on a prepaid basis to subscribers who have submitted personal identity-confirming information for storage within the network database and to be used for identity confirmation purposes at each subsequent occurrence of attempted network access. An on-line computer-accessed website would be provided for the communication link so that local telephone numbers can be used and long distance charges avoided, and so that other information can be exchanged between subscribers such as e-mail and information about items for sale, upcoming events, and available jobs. It is contemplated for the system to comprise a minimum of two control stations, at least one privacy booth in the vicinity of each control station, a local e-mail station with optional ATM capability in the vicinity of each control station, and a plurality of remote e-mail/ATM stations each placed in a secure monitored location, such as a restaurant, bar, or hotel lobby, to prevent theft or vandalism. Once the people desiring such communication have subscribed to the service and paid the designated subscription fee, each would be given a unique access code and assigned a unique e-mail address that would be added to a computer database of subscribers. Subscriber information would also be collected and added to the computer database, including a digital photograph of the subscriber, as well as one or more fingerprints, a sample of the subscriber's speech patterns, and/or additional information about the subscriber when additional layers of security are desired, such as when identical twins or triplets want to simultaneously become subscribers. Thereafter, when a subscriber desires access to the network and enters a password on a personal computer, personal digital device, via a control station, through a local e-mail station, or through a remote e-mail/ATM station, a current digital photograph of the person attempting access is taken and compared to the original digital photograph stored in the computer database. In the most preferred embodiment of the present invention fingerprint scanning and voice recognition would only be required of the subscriber when photo identification is problematic. Upon successful identification of the person as a network subscriber, he or she is provided with instant access to all services for which a monthly fee has been prepaid. Optionally, digital photographs could also be taken of non-subscribers using limited services of the subscriber network on a unit cost basis for a prepaid transaction fee, with the photographs being maintained only for a predetermined period of time after which they would be purged from the network database.

Subscribers remote from one another would be able to schedule videoconferences in advance, at regular intervals when desired. Immediately prior to the scheduled visual conferencing time, each subscriber or group of subscribers would be given an enclosed room by a local technician in which to conduct the visual communication in private, equipped at a minimum with a high resolution monitor, a live video capture camera, one or more audio speakers, at least one microphone, a writing surface, and at least one piece of furniture to comfortably seat them. A telephone and pneumatic tube could be provided when additional customer service options are desired. Computer equipment function for the visual communication would be handled by a skilled computer technician located at each network office where a subscriber intending to be a part of the visual communication. In the preferred embodiment an independent e-mail station in proximity of the privacy booths but not connected directly to it, would allow subscribers to independently access written e-mail messages or still images sent to them by another subscriber, and receive a printed copy of each such message. No technician would be required. A variety of financial transactions could also be accomplished at this type of local e-mail station, particularly when it also had ATM capability. To send an e-mail message to another subscriber, all a subscriber would have to do is type their unique password on a keypad, also type the name of the intended recipient subscriber on the keypad, and then insert the recorded message or picture into the scanner provided. A local or networked central processing unit would access the subscriber database, determine from the database the appropriate e-mail address of the intended recipient subscriber or subscribers, direct the scanner to scan the recorded message, and then send the scanned image to the named recipient subscribers' e-mail addresses without creating a file for the image elsewhere in the computer's memory, after which it would direct the scanner to return recorded message or picture to the sending subscriber. The transmittal would be prompt and the privacy of the communication would not be compromised. Should a subscriber want help in sending a private pre-written e-mail message to another subscriber, it could be given to a technician at the local control station with the names of the intended recipients and the transmitting subscriber's unique access code. The message or picture would then be scanned unread by the technician, automatically transmitted by the computer to the e-mail addresses of the intended recipient subscriber or group of recipient subscribers without creating a computer file for the transmitted message other than at the e-mail address of the intended recipient subscribers, after which the technician would return the recorded message unread to the transmitting subscriber. After the recipient subscriber accesses each e-mail message, in the preferred embodiment the computer would automatically delete the message from the recipient subscriber's e-mail address unless directed not to do so by the recipient subscriber, thus preserving the privacy of personal communications. The network subscription fee could include a predetermined number of e-mail transmittals during a pre-set period of time without additional charge, which would be monitored by the computer through the subscriber database, or in the alternative subscribers could be allowed the option of paying a set fee for each e-mail transmission. E-mail messages would be accessible by the recipient subscriber without paying a fee, any such expenses being covered by the fee paid by the transmitting subscriber. In the alternative, e-mail messages could be sent and received through remote e-mail/ATM stations each having a scanner, a printer, a display screen, and a keypad for data entry. Upon entry of an access code and/or the payment of a fee, a recorded message could be scanned, automatically sent to the e-mail address of the recipient, and promptly returned to the sender without having a computer file made for the message in any other location than the e-mail address of the intended recipient subscriber or subscribers. While the scanned image is being processed, a blinking light visible to the sender could be activated to indicate scanner operation. Sending subscribers would only need to remember and type their own access code, in addition to the name of the user. They would not be required to know the e-mail address of the recipient subscribers. To receive messages, receiving subscribers would only have to type their own unique access code on a keyboard or keypad, after which the computer would automatically direct all messages at the recipient subscriber's e-mail address to be automatically printed for the recipient subscriber. If the e-mail address contained no messages, it is contemplated that the recipient subscriber would be given a recorded message so indicating the lack of messages so there would be no question in the mind of the recipient subscriber as to whether messages had been received. Also, after printing, it is contemplated for the computer to automatically delete the message unless instructed by the recipient subscriber to retain it for a short period of time. It is contemplated at a minimum for e-mail stations placed in locations remote from a control station to have scanners, keyboards, and printers for the private transfer of previously composed messages, letters, and/or pictures. Any of the e-mail stations could also comprise an automated teller machine (ATM) so that people wanting to send money during a visual communication or to pay for the transmittal of e-mail messages would have the funds available to do so. During visual image capture, a blinking light or other visual or audio form of user notification could be employed to identify to the user that a camera or other means of image capture is being operated. It is contemplated that remotely located e-mail/ATM stations would be placed in supervised locations, such as in other business establishments to include but not limited to restaurants, hotels, bars, convenience stores, grocery stores, drug stores, shopping malls, theaters, bus stations, and airports.

To exchange money during a website visual communication of the present invention, the two corresponding subscribers would decide on an amount to be transferred in front of two network technicians. Then within view of the camera the donating subscriber would hand the designated amount of money to a technician present at his or her user location. At the recipient subscriber's location, the recipient's local technician would count a sum of money identical to that given by the donating subscriber to his or her local technician and hand it to the recipient subscriber on camera, after which the recipient subscriber would sign documentation confirming his or her identity as well as receipt of the designated amount. The donating subscriber could also be given a receipt or other documentation for the transaction. In the alternative, a digital photograph could be taken of the donating and recipient subscribers for confirmation purposes. Depending upon the amount of money to be transferred, a technician at the recipient's location would then on camera give the recipient the designated amount of money if it is a small sum, or in the alternative a smart card, check, or other type of easily cashed voucher would be handed to the recipient on camera, with appropriate documentation as needed. Monetary exchange would be prompt and the donating subscriber would have real-time confirmation that the money transfer had been made. Visual conference advertising could also take place, before, during, or after the transmission of images, with such advertising relating to available financial services, insurance, real estate transactions, vacation packages, and the like. In the alternative, particularly if the recipient subscriber was to be transferred a large amount of cash and did not have a bank account or virtual present invention account to use in processing the check or voucher, the recipient would have the option to choose a pre-selected affiliate financial institution through which prior arrangements had been made and that had agreed to release finds to such recipients within a short period of time after receipt of a communication from the local technician that included the recipient subscriber's picture and an identification of the amount to be transferred to the recipient subscriber. In the alternative, the affiliate financial institution would have access to the identity confirming information in the present invention database that was taken for security purposes relating to the visual communication money transfer. It is contemplated that the security information could include a system-generated or user-generated password, in addition to image capture, biometric calculations, fingerprints, voice recognition, selected personal information, and/or a combination thereof. A profile of the intended recipient of funds transferred via the present invention system could also be encrypted and/or incorporated into the check, voucher, or smart card for authentication/identification use by the affiliate financial institution Also, at some time before, during, or after the visual communication, its participants could be given the opportunity to open a bank account with affiliate financial institution. A further money transfer alternative could involve the local and remote e-mail and e-mail/ATM stations. One procedure would involve the donor arranging money transfer by filling out a standardized money transfer form and paying a local technician the amount to be transferred, after which a copy of the form would be e-mailed to the intended recipient subscriber. A security code known only to the recipient subscriber but not included on the e-mailed copy of the form could be added to the original form by the technician for later verification. When the recipient subscriber receives the e-mailed form, he or she would take it to a local control station. After the recipient subscriber's local technician verifies the security code through the donating subscriber's local technician. The funds would be released to the recipient subscriber as cash, a negotiable instrument, or as a result of the recipient subscriber's local technician sending a visual image of the recipient to a cooperating bank. Other variations in money transfer using the present invention can involve recipient notification of money transfer via e-mail, pager, voice mail, or mobile phone message, whereafter the recipient contacts the donor for the code required for money access. Should either of the visual correspondents desire a up-to-date still or moving picture of the others with whom he or she is communicating, the technician at the location of the subscriber wanting the image can activate video-recording equipment at any designated time during the visual communication and thereafter provide the image or images to the user before he or she departs the premises. A window in the privacy booth, or a signal light on the outside of the booth in view of a technician at the control station, could be used to signal the technician of the appropriate time to begin image capture. Means of identifying the start of image capture can include any audio or visual equipment or device. The image preservation, as well as all communication, would be accomplished through computer software programming and to insure privacy for the users, and no record of the communication except the copy given to the user as he or she concludes the video communication session would be preserved thereafter. Also, instead of having a local technician, transactions can be made through a service center, with video and/or image capture being sent to the sending subscriber or recipient subscriber after conclusion of the visual communication by a variety of means, including but not limited to email, governmental or private postal/delivery service, and/or transfer to a designated web folder within the system. If the images are mailed, any standard format acceptable to the recipient is contemplated, including but not limited to compact disk (CD), videotape, diskette, and DVD. Since it is contemplated for the visual conferencing services to be scheduled in advance, a record of people using such services would necessarily be kept prior thereto, however, it would only be kept for a limited period of time following each conference, possibly until the subscriber pays for the next subscription fee. Additional customer services could be made available to those using privacy booths through use of a connected telephone or pneumatic tube placing those in the privacy booth in direct communication with remotely located customer service personnel, such as opening an account, applying for a loan or mortgage, or paying bills. Walk-in service for visual conferencing would be possible, but not frequently requested since prior arrangements between remote subscribers would be necessary to insure that both were simultaneously present at a local control station for conduct of the conference. In the alternative, e-mail could be accessed at any time without a prior reservation and the e-mail or control stations would maintain no paper record of the content of any e-mail transaction. The number of e-mail transmissions made by subscribers within a designated subscription period might be temporarily maintained in the subscriber database when needed for billing purposes, however even that information would be unnecessary if each e-mail transmission was paid for by the sending subscriber at the time it was sent.

Use of the e-mail stations by people more knowledgeable about computer operation can provide them with a diverse assortment of options, including the execution of many financial transactions such as but not limited to sending money to one or more other subscribers, paying bills, cashing checks, issuing paychecks, exchanging currencies, purchasing prepaid telephone cards, purchasing prepaid debit cards, purchasing money orders, purchasing transportation or entertainment tickets, purchasing goods and services such as groceries or gas, purchasing prepaid software applications, purchasing bandwidth to send large files or for videoconferencing purposes, paying traffic tickets, and pre-paying entertainment costs. As part of the application process for becoming a network subscriber, a digital photograph of the person is taken and entered into the computer database of the present invention, along with other identifying information about the subscriber, such as but not limited to social security number, full name, birth date, and/or full address and telephone number. Additional layers of security can also be employed in varying combinations as part of the application process, including but not limited to the taking of one or more fingerprints and establishing voice recognition patterns. Thereafter, a subscriber wanting to perform a variety of financial transactions through use of the present invention, whether positioned in front of an e-mail station having ATM capability at one of the network offices or in front of a stand-alone remote e-mail/ATM network accessing station, could do so by simply entering a discrete password and allowing the system to take a current digital photograph, fingerprint, and/or voice pattern sample and compare it to the digital photograph and other data already on file in its computer database. When money is transferred to another network subscriber, the recipient subscriber can choose to receive a message about the transfer via e-mail, pager, voice mail, or mobile phone, whereafter the recipient subscriber can proceed to the nearest network-accessing unit having automated teller machine capability to obtain all or part of the transferred money. Further, a video screen, microphone, camera, and speaker or speakers associated with a local e-mail station in a network office, or as part of a stand-alone remote e-mail/ATM station, can further assist subscribers by providing them with full video motion customer service and alternatively provide the subscriber network with the opportunity for revenue generation through full video motion advertising.

The description herein provides preferred embodiments of the present invention but should not be construed as limiting the scope of its telecommunication system and method. For example, variations in the size of the privacy booth and the selection of electronic equipment available therein; whether during transactions a user of the present invention system has the assistance of an available local technician or a remote customer service representative; the type of printers used for the local and remote e-mail stations; the type of access code used by the corresponding subscribers to send and receive e-mail messages; the order in which the visual communication, e-mail, money exchange, and information exchange takes place; the type of digital and other means used for subscriber identification; and the type of fax, scanning, and copying equipment selected for use, other than those shown and described herein, may be incorporated into the present invention. Thus the scope of the present invention should be determined by the appended claims and their legal equivalents, rather than being limited to the examples given.

### BRIEF DESCRIPTION OF THE SEVERAL VIEWS OF THE DRAWINGS

FIG. 1 is a not-to-scale perspective view of one embodiment of a privacy booth and local e-mail station each connected to a central processing unit at a control station.

FIG. 2 is a front view of a virtual bank teller having a telephone and pneumatic tube delivery system for customer service communication.

FIG. 3 is a front view of an email station having a telephone for customer service communication and ATM money dispensing capability.

FIG. 4 is a front view of a preferred wall-mounted remote ATM station of the present invention through which pre-recorded recorded messages can be sent and received with notifications, and through which financial, purchase, information gathering, account management, and file management, and other transactions can be conducted.

FIG. 5 is a perspective view of a preferred stand-alone remote ATM/KIOSK station through which pre-recorded recorded messages can be sent and received with notifications, and through which financial, purchase, information gathering, account management, and file management transactions can be conducted.

### DETAILED DESCRIPTION OF THE INVENTION

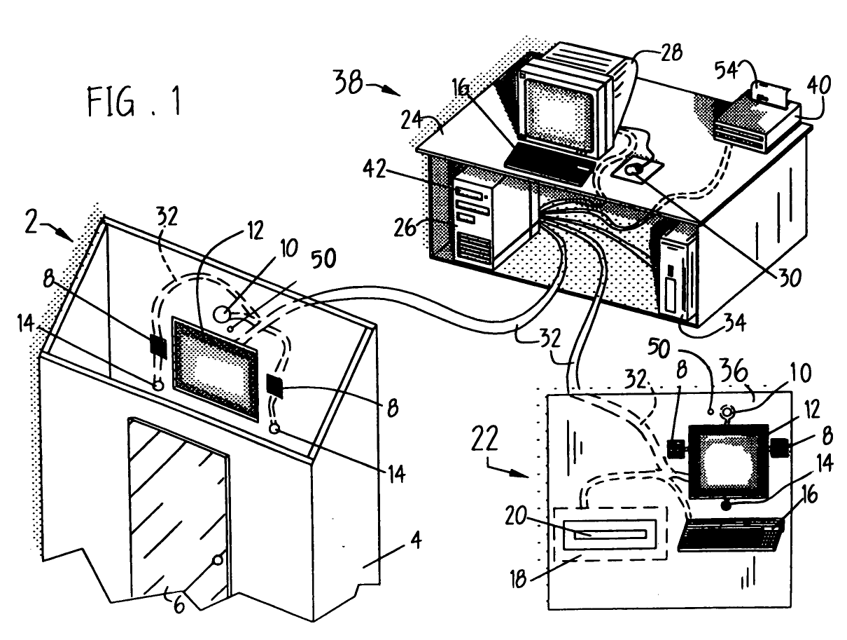

The present invention provides a computer-aided system and method for telecommunication that would allow people who may be unskilled in computer operation, those not having available to them the necessary personal computer equipment for real-time visual communication with remotely located family members and friends, and those skilled in computer operation with a personal computer connected to image capture equipment, such as a netcam, to conduct a wide variety of telecommunication and financial transactions at a cost that is relatively low when compared to communication alternatives, in addition to providing an option for correspondents to promptly and securely transfer money from one to the other during such communication with instant transfer confirmation and notification by a variety of means, and providing an option for capturing still and moving images of any visual communication participant for later use by one of their remote correspondents. An Internet website (not shown) would be provided for the communication link so that local telephone numbers can be used and long distance charges avoided, and so that other information (not shown) can be exchanged between subscribers such as the e-mail transfer of recorded messages and images, as well as classified ads, notices about items for sale, notices about upcoming events, descriptions of employment opportunities, and other similar types of information that can be directed toward targeted groups of recipient subscribers. In the preferred embodiment it is contemplated for visual and e-mail communication to be available on a subscription basis to family, friends, and other people remotely located from one another who would benefit from periodic visual communication so that once each subscriber is assigned an e-mail address and an access code, the correspondents' names, addresses, and codes are stored in a subscriber database for use by central processing unit 26 in identifying recipients of e-mail communications. Also at initial registration, other personal information is also collected from the subscriber, such as biometric measurements, fingerprints, voiceprint, and photo or digital image for later identity confirmation. At least one digital image of each user of the present invention is captured at the time of system access, with the image being stored if not already a part of the existing database. Although on-demand use is contemplated for most equipment employed as a part of the present invention system, to avoid conflicts in use of privacy booths 2 by subscribers, it is contemplated for visual communications using them to be scheduled in advance. Then, at the appointed time, each visual correspondent would be given an enclosed private room in which to conduct a visual communication, one embodiment of such a privacy booth 2 being shown in FIG. 1. It is not required that privacy booth 2 have total enclosure around a visual correspondent, as long as privacy is preserved. Preferably, it is contemplated for privacy booth 2 to be equipped with a high resolution monitor 12, a live video capture camera 10 that may be connected to an activation light 50 to let correspondents know when they are being filmed, audio speakers 8, at least one microphone 14, a writing surface 58, and at least one piece of furniture 44 that can comfortably seat one or more adults. A second light 50 in FIG. 2 (above window 46), and/or a buzzer, bell, or other audio device (not shown), along with a small window, number 46 in FIG. 2, could be installed through one of the walls of privacy booth 2 for signaling a local computer technician (not shown) of the need for his or her assistance, such as for the initialization of the capture of still or moving images of a remote correspondent for one or more local correspondents. Set up and activation of the visual communication equipment would be accomplished by a technician skilled in computer and electronic equipment operation through use of a central processing unit 26 at a control station 38. In the alternative and where appropriate, although not shown, visual communication equipment and/or camera 10 can be activated remotely from a customer service assistance center. The amount of equipment control options within a privacy booth 2 or at an e-mail station 22, available to subscribers for adjusting the operation of the visual communication and e-mail communication equipment, would be limited to avoid subscriber mistake and related equipment malfunction. It is contemplated for the system of the present invention to comprise at least one control station 38 and a plurality of remote e-mail stations 62 and/or 82 each placed in monitored locations, such as hotels, restaurants, or grocery stores to deter theft and vandalism. In addition, the present invention system could also comprise one or more privacy booths 2, email stations 22 configured for communication and text/image transfer, virtual bank tellers 2′, or email stations 22′ having an ATM for e-mail communication as well as financial transactions involving the automated dispensing of cash to the user. However, instead of cash dispensing, alternative options are available, such as but not limited to having transferred money being temporarily stored in a virtual savings account within the system for an indefinite period of time, or transferred to a smart/debit card. A subscriber using email stations 22 or 22′ would not have to know the recipient subscriber's e-mail address, only the name of the intended recipient subscriber or identification of the group of subscribers to which the e-mail communication is directed. Also, communication and/or financial transactions conducted via the present invention can be accomplished using keyboards 16, touch pads 68, voice activation, and/or touch screen technology (not shown). Since security is a primary concern for the present invention system, each preferred remote ATM station, wall-mounted embodiment 62 or stand-alone ATM/KIOSK embodiment 82 would have the capability of producing an audible signal, visual signal, and/or electronic communication with the control station and/or police should it be vandalized or the subject of an attempted theft. Further, to minimize the risk of vandalism and/or theft, each remote ATM station should also have the capability of sending periodic reports to a customer service center (not shown) or control station 38 to identify situations where cash replenishment is required, or in the reverse when cash reserves exceed a pre-determined safe level and excess cash should be removed to prevent vandalism or theft. It should also be noted that a full-service unit of the present invention system, such as the ATM/KIOSK 82 shown in FIG. 5, may not be applicable to small towns. Therefore, it is considered within the scope of the present invention to have a present invention embodiment only with a keyboard, vault for money collection and dispensing, and a central processing unit capable of monitoring email communication. Further, it should be recognized that some areas will not require video, while others may want or not want printed messages. However, for all repeat transactions and continuing subscribers, a smart card with personal identity information will be the key to system access by a user, and in geographical areas where computer use is uncommon, a local technician can be made available to help users send and receive email communication and conduct needed financial transactions.

FIG. 1 shows one embodiment of the present invention through which visual communications and transfer of text and images via email can be conducted. FIG. 1 shows a control station 38 electronically connected by data transfer cables 32 to a privacy booth 2 and also to an e-mail station 22. Where appropriate and feasible, wireless connection is also contemplated. Instead of control station 38 being positioned in the same building as privacy booth 2 and e-mail station 22, although not shown, a remote customer service center could be employed to perform many of the same functions shown in FIG. 1 to be processed through control station 38. Preferably, as shown in FIG. 1, although not limited thereto, each privacy booth 2 used to conduct both audio and visual communication between subscribers (not shown) in remote locations would have a door 6 that can be closed, soundproofing wall and ceiling materials (not shown) where needed to prevent people in adjoining privacy booths 2 from hearing conversations through the walls 4 of adjacent privacy booths 2, and a ceiling although a ceiling is not shown in FIG. 1 for illustrative purposes so that the interior of privacy booth 2 can be seen. In the alternative, similar to the virtual bank teller unit shown in FIG. 2, privacy booth 2 could be less rigidly structured with partitions instead of walls, as long as the privacy and confidentially of communication and financial transactions can be preserved. In place of using the virtual bank teller unit 2′ shown in FIG. 2 to conduct video communication with bank customer service personnel, a person using a home computer would be able to do the same via the present invention system. However, FIG. 1 also shows the interior of privacy booth 2 having a high resolution monitor 12, a live video capture camera 10, a camera activation light 50, two audio speakers 8, and a microphone 14 and connection thereof to central processing unit 26 by data transfer cables 32. It is contemplated that volume of speakers 8 and microphone 14, as well as the contrast and brightness of high resolution monitor 12, would be controlled by a skilled technician (not shown) to avoid user mistake, reduce equipment malfunction, and enhance the efficiency of present invention operation.

It is also contemplated for the number of controls and subscriber options available at e-mail station 22 to also be minimal to avoid subscriber induced malfunction. FIG. 1 shows a preferred embodiment of a local e-mail station 22 having a keyboard 16 and a printer 18 hidden from subscriber view behind wall 36. FIG. 1 further shows e-mail station 22 having a display monitor 12, digital camera 10, camera activation light 50, microphone 14, and speakers 8 to assist in subscriber identity confirmation and customer service options. The arrangement of keyboard 16, printer 18, display monitor 12, digital camera 10, microphone 14, and speakers 8 can be different that that shown in FIG. 1, however, digital camera 10 and microphone 14 should be positioned for optimal use by a person situated in front of keyboard 16 and entering a personal code to access the subscriber network. Keyboard 16, printer 18, display monitor 12, digital camera 10, microphone 14, and speakers 8 are all connected to central processing unit 26 at control station 38 through data transfer cables 32. It is contemplated for subscribers' sole access to printer 18 to be through opening 20. Printer 18 maintenance, including the periodic addition of paper and replacement of imaging powder or ink cartridges, would be handled by one of the skilled technicians (not shown) working at control station 38. Also, access to controls for display monitor 12, digital camera 10, microphone 14, and speakers 8 would be limited to subscribers (not shown) using e-mail station 22 to minimize opportunities for malfunction. It is contemplated for the selection of electronic equipment at control station 38 to vary, but at a minimum to include a central processing unit 26, keyboard 16, and video recording equipment such as VCR 34. FIG. 1 shows control station 38 having a desk unit 24, with a keyboard 16, monitor 28, mouse 30, and printer/scanner/fax 40 positioned on top of desk unit 24. Positioned below monitor 28 FIG. 1 shows control station 38 having a central processing unit 26 with a drive unit 42 for removable information storage diskettes (not shown), VCR 34, and data transfer cables 32 connected between central processing unit 26 and monitor 28, printer/scanner/fax 40, privacy booth 2, and e-mail control station 22. Although not shown and optional according to user preference, it is contemplated for control station 38 to comprise individual printer, scanner, and fax devices instead of or in addition to printer/scanner/fax 40.

FIG. 2 shows a preferred embodiment of virtual bank teller unit 2′ equipped with one television monitor 12 with touch screen menu options (for customer service assistance, displaying visual communication images, advertising, email messages, and documents), one live video capture camera 10 (for customer service use and recording images for security/identification purposes), one camera activation light 50 (to let the user know when camera 10 is being operated), two audio speakers 8 (for customer service communication), one microphone 14 (for customer service communication and/or recording voiceprints), one writing surface 58 (for any needed support surface use), a telephone 100 (for customer service assistance), a pneumatic tube delivery system 102 (for customer service communication), and three pieces of furniture 44 that can comfortably seat subscribers (not shown). Electronic connection between associated components can be via cable 32 or wireless technology. The number, size, and positioning of high resolution monitors 12, cameras 10, camera activation lights 50, audio speakers 8, microphones 14, writing surfaces 58, telephones 100, pneumatic tube delivery systems 102, and pieces of furniture 44 relative to wall 4 are not critical, although pneumatic tube delivery system 102 would be sized to send and receive such items as bank statements, financial transaction documents, pieces of identification, coupons, money orders, smart cards, and tickets. A secure atmosphere is provided to clients, remote from customer service personnel. The service provided through virtual video bank teller unit 2′ will also provide access to deposits and transactions to the customers at any branch or remote place without risk of hazard to institution employees. Virtual video bank teller unit 2′ can be used with banks and other financial institutions, and their affiliates via an ATM supported network. Customer can use the same service offered through virtual video bank teller unit 2′ in any financial institution, shopping center, building lobby, or drive-thru service. To start a transaction using virtual video bank teller unit 2′, a customer will introduce his/her Debit Card or system Virtual Card to virtual video bank teller unit 2′, and then enter a personal password or activate the ATM Teller Phone for customer service assistance. When the identification process is concluded and the user is accepted by the present invention system, it will send the user's personal information to any affiliated financial institution or company that ultimately corresponds with the customer so that the customer and get the needed information or assistance, with that assistance being in his/her preferred language. FIG. 2 shows a second light 50 and or buzzer 48 to the right of furniture 44, in addition to a small window 46, could be used for signaling customer service personnel to obtain face-to-face assistance. Otherwise, servicing personnel (not shown) can be located in another part of the building housing virtual banking teller 2′, or in a completely separate facility. Writing surface 58 could be used for a recipient subscriber to sign a money receipt or fill out any type of document (not shown), or to temporarily positions papers or pictures that one subscriber wants to share with his or her visual correspondents. While pneumatic tube delivery system 102 would be used for transport of papers and small objects (not shown) to nearby technicians and customer service personnel, camera 10, microphone 14, and telephone 100 are used for telecommunication with more distant technicians and customer service personnel (not shown), as well as to maintain the privacy of select comments intended for only one of the people sharing a privacy booth. Immediately prior to a visual communication, equipment would be activated by a technician skilled in computer and electronic equipment operation through use of a central processing unit 26 at a control station 38 or a remote customer service center (not shown). The amount of control options available to subscribers within a privacy booth 2, or at an e-mail station 22, would be limited to avoid subscriber mistake and equipment malfunction. Although not shown, privacy booth 2 could also be equipped with a keyboard 16 so that anyone in a privacy booth 2 and having computer skills could also conduct one or more financial transactions independently from the technicians at control station 38, including but not limited to the transfer of money, purchase of sports and entertainment tickets, and the purchase of tickets needed for travel.

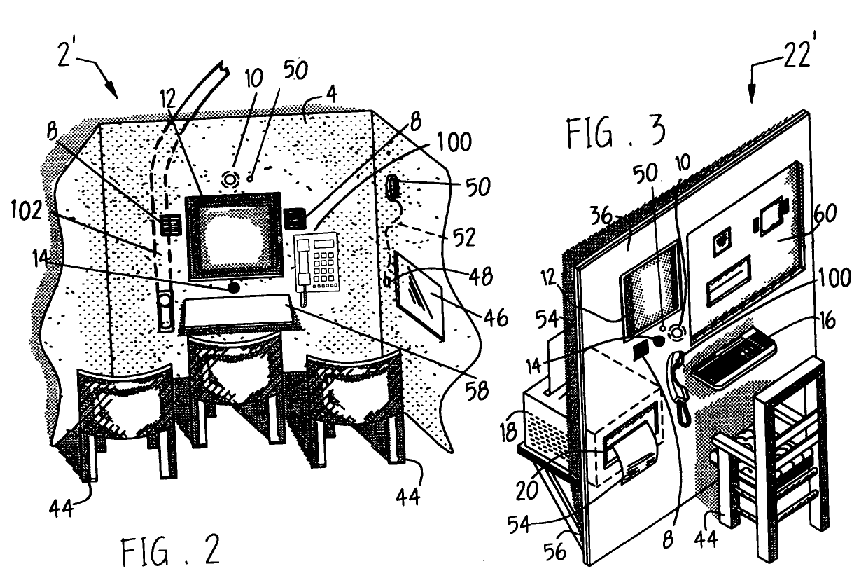

FIG. 3 shows a preferred embodiment of an e-mail station 22′ having keyboard 16, a piece of furniture 44 in the form of a chair positioned in front of keyboard 16, a printer 18 hidden from view of a user (not shown) but accessible through an opening 20 in wall 36 with paper 54 containing an e-mail message or a statement identifying the lack of e-mail messages extending through opening 20. FIG. 3 further shows a monitor 12, one digital camera 10, a camera activation light 50, an audio speaker 8, one microphone 14, a telephone 100 and an optional automated teller machine 60. The number, size, and positioning of monitors 12, cameras 10, camera activation lights 50, audio speakers 8, microphones 14, telephones 100, and pieces of furniture 44 relative to wall 36 are not critical. FIG. 3 also shows printer 18 sitting upon a supporting surface 56 behind wall 36. It is not critical whether supporting surface 56 is attached to wall 36 or separate from wall 36, and long as supporting surface 56 is sufficiently large and sturdy to permit printer 18 to properly and safely function without undue risk of falling therefrom. It is also not critical whether supporting surface 56 is smaller than, the same size as, or larger than the footprint of printer 18, however, it is not contemplated for supporting surface 56 to have an unduly large perimeter dimension. In the preferred embodiment e-mail station 22′ would allow subscribers (not shown) to access messages sent to their assigned e-mail address and give them automatic printed copies of the messages received once they have typed their e-mail address, their unique access code, or both, on keyboard 16. If no messages had been received in the interim since the last time the subscriber checked his or her e-mail address, it is contemplated that the central processing unit 26 shown in FIG. 1 would direct printer 18 to print a statement on paper 54 identifying the lack of messages for the subscriber. FIG. 3 also shows e-mail station 22′ having an optional automated teller machine 60 so that people wanting to pay for the cost of sending e-mail messages, to have money to send to a visual correspondent, or to have money to pay for off-site purchases would have the necessary funds available to do so. To exchange money through the website during a visual communication using monitor 12 in the preferred embodiment of the present invention, the two visual correspondents (not shown) would decide on an amount to be transferred. Then the donating correspondent while in front of the camera 10 in his or her privacy booth 2 would hand the designated amount of money to a local technician present in the donor's privacy booth 2 who is also positioned in front of camera 10 so as to be visible to both the remote correspondent and a remote technician in the recipient correspondent's privacy booth 2. At the recipient subscriber's location and in front of his or her camera 10, the recipient would sign documentation (not shown) confirming his or her identity as well as receipt of the identified money transfer amount. A technician at the recipient's location would then on camera 10 give the recipient the identified amount of money. The monetary exchange would be immediate and the donor would have real-time confirmation that the money transfer had been made. In the alternative or if the identified money transfer amount is large, so as not to make the recipient's control station 38 a target of theft or vandalism, the technician at the recipient's location could either give the recipient a check or bank voucher. Should a bank voucher be used, the recipient's technician would have made prior arrangements with a bank in the vicinity of control station 38 to allow money transfer to recipient subscribers. Then immediately after money transfer, the recipient's local technician would capture the recipient's image on camera 10 and through central processing unit 26 send the recipient subscriber's image to the bank so that only a person looking like the recipient and producing a bank voucher with a serial number and in the amount identified in the communication received by the bank's computer or fax machine would be able to retrieve the transferred money amount. With the bank having a clear and detailed picture of the recipient, it is contemplated that the opportunity for someone to obtain the transferred money by fraud would be greatly reduced. Should either of the correspondents during a visual communication desire an up-to-date still or moving picture of remote correspondent, the technician at the location of the correspondent desiring the image can be requested to activate a video-recording device at any designated time during the visual communication and after the conclusion of the visual communication provide the finished still and/or moving image or images to the correspondent before he or she departs the premises. The image preservation, as well as all communication, would be accomplished through computer software programming and to insure privacy for the correspondents, no record of the communication other than the copy given to the correspondent as he or she concludes the video communication session would be preserved thereafter. The same system of money transfer would be available for use with e-mail station 22′, although privacy would not be as great as in a privacy booth 2. However, in addition, skilled computer operators could also conduct a wide variety of financial transactions through the subscriber network using keyboard 16, to include paying bills, making payroll payments to employees, making purchases of goods and services, immediate transfer of money to an individual recipient whereby that recipient is given a pre-selected form of message informing the recipient that money is available for his or her use, the transferred amount, where the awaiting funds are located, the code needed to access the funds, and the form in which the funds are available.

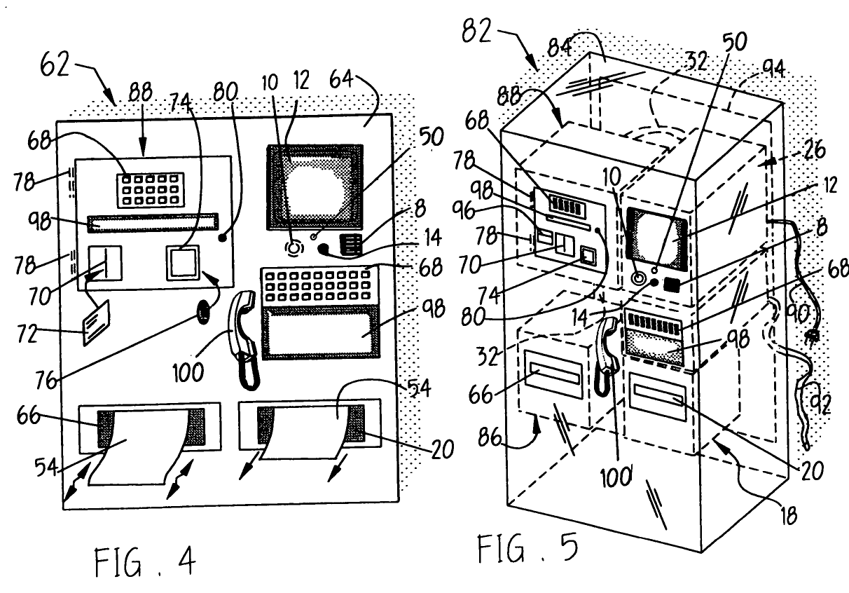

FIG. 4 shows a preferred embodiment of a wall-mounted remote ATM station 62 having two keypads 68 each positioned adjacent to a different display screen 98, a printer opening 20 through which a user could receive e-mail messages on paper 54, and a separate scanner opening 66 through which a user could introduce recorded message or images on paper 54 for scanning and transfer to another subscriber e-mail address in the subscriber database (not shown). Depending upon the scanner 86 used, two scanner openings 66 might be required. ATM station 62 could be used as a substitute for the e-mail station 22 shown in FIG. 3, simultaneously with e-mail station 22 so that more than one subscriber at a time can access individual e-mail messages, or as a remote station placed in a business location such as a hotel, restaurant, or grocery store (not shown). It is contemplated for either paired keypad 68 and display 98 in FIG. 4 to be used by the sending subscriber to type his or her assigned access code and the name of the intended subscriber recipient. Should the transferred message be a classified ad or sale notice intended for all subscribers in the subscriber database or a pre-selected group of subscribers in the subscriber database, the sending subscriber upon prompting by display 98 would simply type the word “all”, “family”, “sisters”, “all women”, “all men”, or some other pre-arranged group term and the computer would be programmed to automatically send the message to all such recipient subscribers. Since it is contemplated for ATM station 62 shown in FIG. 4 to optionally be placed in remote locations unsupervised by skilled technicians except for the regular visits by maintenance personnel, the embodiment of ATM station 62 shown in FIG. 4 also has an on-site payment unit, shown in FIG. 5 as number 88, configured for accepting coins 76 and credit/debit cards 72 when the subscriber is required to pay immediately prior to transmission for each message that he or she desires to send to others in the subscriber database. FIG. 4 shows on-site payment unit 88 having a keypad 68 for typing information such as a bank-assigned access code and the number of messages to be sent, a display 98 for communicating with the sending subscriber, a coin vault 74, a credit/debit card slot 70, hinges 78 for allowing the front cover of on-site payment unit 88 to be opened for retrieval of coins 76, and a lock 80 to prevent unauthorized retrieval of coins 76. Display monitor 12, digital camera 10, camera activation light 50, microphone 14, speaker 8, and telephone 100 can be used for subscriber identity confirmation as well as customer service options. The positioning of monitor 12, digital camera 10, camera activation light 50, microphone 14, speaker 8, telephone 100, scanner opening 66, printer opening 20, on-site payment unit 88, keypad 68, and display 98 are not critical to wall-mounted ATM station 62 and it is contemplated for wall-mounted ATM station 62 to have varying arrangements of subscriber communication devices as well as differing embodiments such as one in which a combined scanner/printer device such as scanner/printer/fax 40 is used to both send e-mail messages and receive them through a single aperture similar to either scanner opening 66 or printer opening 20. Another possible embodiment variation of wall-mounted ATM station 62 would include a slot for receiving currency in addition to or in place of coins, and/or an opening through which a payment receipt can be given to the sending subscriber, such as receipt dispensing slot 96 in FIG. 5. Although not shown in FIG. 4, but similar to that shown in FIG. 5, it would be critical for wall-mounted ATM station 62 to have an electrical connection to a remote power source, a telephone access connection, and a central processing unit with a modem for accessing the Internet website and information in the subscriber database.

FIG. 5 shows a preferred embodiment of a stand-alone ATM/KIOSK 82 having two keypads 68 each positioned adjacent to a different display screen 98, a printer opening 20 through which a user could receive e-mail messages, and a separate scanner opening 66 through which a user could introduce recorded message or images for scanning and transfer to another subscriber e-mail address in the subscriber database. Keypads 68, displays 98, printer opening 20, and scanner opening 66 are all shown in FIG. 5 to be connected through the same wall of a cabinet 84. In the alternative if the surroundings of stand-alone ATM/KIOSK 82 permit, printer opening 20 could be positioned through a different wall of cabinet 84 so that a subsequent subscriber could access one of the keypads 68 while the previous subscriber's e-mail messages are being printed. FIG. 5 shows a scanner 86 and a printer 18 positioned respectively behind scanner opening 66 and printer opening 20, although in actual use they each would be hidden from the view of a sending subscriber standing in front of ATM/KIOSK station 82. Although not critical, for ease of use it is contemplated for scanner opening 66 and printer opening 20 to be positioned beneath keypads 68 and associated displays 98. FIG. 5 also shows a central processing unit 26 positioned behind the front wall of cabinet 84 and adjacent to on-site payment unit 88, as well as data transfer cable connections 32 between central processing unit 26 and on-site payment unit 88, scanner 86, and printer 18, in addition to a telephone line 92 and an electric cord 90 being connected to central processing unit 26 and extending through cabinet 84. Although not shown in FIG. 5 it is contemplated for central processing unit 26 to have a modem for accessing the Internet website and information in the subscriber database (not shown). FIG. 5 further shows stand-alone ATM/KIOSK 82 having a display monitor 12, digital camera 10, camera activation light 50, microphone 14, speaker 8, and telephone 100 that can be used for subscriber identity confirmation as well as customer service options. The configuration of cabinet 84 is not critical, and not limited to the rectangular configuration shown in FIG. 5. It is contemplated for stand-alone e-mail station 82 to be employed primarily for use in an off-site location remote from control station 38, however, stand-alone e-mail station 82 could also be used as a substitute for the e-mail station 22 shown in FIG. 3, or wall-mounted ATM station 62 shown in FIG. 4, or simultaneously with either one so that more than one subscriber at a time can access individual e-mail messages. It is contemplated for the paired keypad 68 and display 98 in FIG. 5 to be used by the sending subscriber to type his or her assigned access code and the name of the intended subscriber recipient. Should the transferred message be a classified ad or sale notice intended for all subscribers in the subscriber database or a pre-selected group of subscribers in the subscriber database, the sending subscriber upon prompting by display 98 would type the name of the recipient subscriber or a pre-arranged group term identifying the pre-selected and the computer would be programmed to automatically and promptly send the message to all of the identified recipient subscribers. Since it is contemplated for stand-alone ATM/KIOSK 82 shown in FIG. 5 to optionally be placed in remote locations unsupervised by skilled technicians, the embodiment of stand-alone e-mail station 82 shown in FIG. 5 also has an on-site payment unit 88 configured for accepting coins 76 and credit/debit cards 72 when the subscriber is required to pay immediately prior to transmission for each message that he or she desires to send to others in the subscriber database. FIG. 5 shows on-site payment unit 88 having a keypad 68 for typing information such as a bank-assigned access code and the number of messages to be sent, a display 98 for communicating with the sending subscriber, a coin vault 74, a credit/debit card slot 70, a subscriber receipt dispensing slot 96, hinges 78 for allowing the front cover of on-site payment unit 88 to be opened for retrieval of coins 76, and a lock 80 to prevent unauthorized retrieval of coins 76. FIG. 5 further shows a rear door 94 in cabinet 84 for emergency access to and routine maintenance of on-site payment unit 88, central processing unit 26, scanner 86, and printer 18. Although not shown and not critical to stand-alone ATM/KIOSK 82, it is considered within the scope of the present invention for cabinet 84 to have support feet, rollers, or wheels connected to its bottom surface for ease in moving cabinet 84 when necessary for maintenance technicians to gain access to rear door 94. The positioning of monitor 12, digital camera 10, camera activation light 50, microphone 14, speaker 8, telephone 100 scanner opening 66, printer opening 20, on-site payment unit 88, keypad 68, and display 98 are not critical to stand-alone ATM/KIOSK 82 and it is contemplated for stand-alone ATM/KIOSK 82 to have varying arrangements of subscriber communication devices as well as differing embodiments such as one in which a combined scanner/printer device such as scanner/printer/fax 40 is used to both send e-mail messages and receive them through a single aperture similar to scanner opening 66 or printer opening 20. Combining the scanner and printer functions into one device would reduce the cost of stand-alone e-mail station 82, however, it would also reduce its functionality in instances of malfunction. Having independent scanners 86 and printers 18 would allow each to continue to function when the other becomes inoperative, so that a sending subscriber could still transmit an e-mail message through scanner 86 even if printer 18 was not working, or vice versa. Another possible embodiment variation of stand-alone ATM/KIOSK 82 would include a slot for receiving currency in addition to or in place of coins. It is contemplated for stand-alone ATM/KIOSK 82 to be placed in supervised locations, such as in a hotel lobby, a grocery store, or a restaurant at a busy freeway exit with a high volume of business from travelers, or one located near an area attracting a high volume of foreign tourists or other visitors.

To use the present invention, technicians skilled in computer and electronic equipment operation, and each in a location remote from the other or other, would set up a central processing unit 26 and connect it to a printer/scanner/fax unit 40, a live video capture/digital camera such as camera 10, microphones 14, video recording equipment such as VCR 34, speakers 8, a high resolution monitor 12, a selection of e-mail stations 22, 62, and/or 82 having optional coin/credit card/debit card activation, an optional automated teller machine 60, an optional scanner 86, a printer 18, keypad 68 for data input, and a display screen 98, the system also having on-line access to a website programmed to provide subscriber e-mail communication. Privacy booths 2 with chairs 44, or other furniture comfortable for subscribers, would also be provided into which those in visual communication with others, including those conducting customer service interviews and/or transactions, could go to accomplish long distance communication out of sight and beyond the hearing capability of others. Optionally, for the convenience of subscribers, a telephone 100 and a pneumatic tube transfer system 102 can be added to each privacy booth 2 to facilitate customer service information and paperwork exchanges. After the technicians set up and make the visual and e-mail communication systems operational, they would use the central processing unit 26 and the website to create a database of subscribers who want to send written e-mail messages and pictorial images to other database subscribers, conduct financial transactions including money transfer as well as visual conferences with other subscribers, in addition to creating an e-mail address for each such subscriber, a web site for each subscriber for information display, and assigning each such subscriber a unique system access code. In addition, at registration identity confirming information is collected from the person wanting to be a subscriber, such as one or more digital photos, one or more fingerprints, a voice print, social security number, full name, full address, date of birth, and other confidential information that might be helpful to avoid future fraud or mistake, such as if the person has any siblings or other relatives with an identical or nearly identical appearance. All such information is stored in the network database and maintained for comparison to similar information collected when the subscriber initially accesses the network website to conduct a transaction. Advertising would be displayed on idle screens 12 in privacy booths 2, in local and remote e-mail and ATM stations 22, 62, and 82, as well as on personal computers and other electronic devices (not shown) used to access the network website from a home, office, hotel, or other site not a direct part of the network infrastructure. Once a subscriber decides that he or she would like to communicate with another subscriber, the subscriber would decide if a visual conference, an e-mail transmission, e-mail receipt, or a combination thereof is desired, and if he or she would like money to be a part of the communication. If only e-mail transmission and receipt is desired and the subscriber does not want help from a technician at a control station 38, the sending subscriber could choose his or her own personal computer or other electronic device capable of making an on-line connection, or approach a remote e-mail station, such as wall-mounted ATM station 62 or stand-alone ATM/KIOSK 82. If only e-mail receipt is desired, e-mail station 22 could be used. The first step in the transaction would be for the subscriber to enter his or her unique assigned network access code into the computer. While the declared subscriber is entering this code, the computer collects current subscriber identifying information and compares it to that initially collected during registration, or updated replacement information in the network database. If the current subscriber identifying information matches that on record in the database, the declared subscriber may access the network website to conduct desired transactions. Payment for the transactions must be made in advance, either by payment of a periodic subscription fee, or a per transaction payment must be made via cash, credit, debit, or similar card immediately prior to conducting the transaction. On-site payment for each transmitted message could be paid at control station 38, ATM station 62, or ATM/KIOSK 82, or through a debit account with the transaction being controlled by the subscriber via his or her own personal computer (not shown). In the alternative, the recurring subscription fee paid by or on behalf of each subscriber could include a pre-selected number of e-mail transmissions per payment period that would not require the payment of a per transaction fee. Once that number of e-mail transmissions is exceeded, central processing unit 26 would indicate to the sending subscriber that on-site payment is required until the start of the next subscription period. Should the sending subscriber need currency to send messages to other subscribers or later transfer money during a visual conference, the sending subscriber could access an automated teller machine with bank-assigned access codes if one were provided in the embodiment of the e-mail station he or she had approached. After obtaining the necessary payment, if needed, the sending subscriber would direct central processing unit 26 to send a message to another person in the subscriber database by prepaying cost of sending each message, either as part of his or her pre-paid subscription fee or on-site payment. Once transmission payment verification is concluded, the sending subscriber would place a recorded message into scanner 86, or a scanner connected to a personal computer or other personal electronic device (not shown), and using keypad 68 type the sending subscriber's unique access code as well as the name of the intended recipient subscriber, or a pre-selected term for a group of intended recipient subscribers, when prompted to do so by display 98. In the alternative, any subscriber having computer skills could compose an e-mail message using a keyboard 16 or keypad 68, and then send it by following the procedure prompts on monitor 12 or display screen 98. Central processing unit 26 would then access the subscriber database to identify the e-mail address of the named recipient subscriber or subscribers, then direct scanner 86 to scan the recorded message inserted through scanner opening 66, and send the scanned image to the identified e-mail addresses without creating a permanent file for the scanner image in the computer's memory, after which central processing unit 26 would direct scanner 86 to return the inserted recorded message to the sending subscriber. E-mail messages from subscribers to non-subscribers could be send by those skilled in computer operation using the network website in the customary manner from personal computers, personal electronic devices, local e-mail stations 22, and remote ATM stations/KIOSKS 62 or 82. If the sending subscriber subsequently checked his or her received e-mail messages and found a message requiring an immediate response, the sending subscriber could also send additional messages in a like manner. However, if the sending subscriber would also like to conduct a visual conference with another person or group of people in the subscriber database, the sending subscriber would then have to approach a control station 38.

Preferably appointments for visual conferences would be set up in advance, or on a recurring basis, but it is also contemplated for visual conferences to be held on short notice where both subscribing correspondents come to control stations 38 remote from one another at a time period during which there is no conflicting subscriber use of privacy booth 2. Immediately prior to the appointed time, a technician at the location of each subscribing correspondent would activate and confirm the optimum operation of speakers 8, microphones 14, high resolution monitors 12, telephone 100, pneumatic tube transfer system 102, and cameras 10 in the privacy booth 2 intended for use, and then direct central processing unit 26 to access the visual conferencing website through which conduct of the intended private communication between people in the subscriber database can be held. After everything is confirmed to be in good working order, each corresponding subscriber would enter a local privacy booth 2. If a still image or moving images of the remote correspondent is desired during the visual conference, or money transfer between correspondents contemplated, each correspondent should so notify his or her local technician prior to entering privacy booth 2. A subscriber desiring a printed image or images of his or her remotely located correspondent would send an audio or visual signal to the local technician to direct central processing unit 26 to direct the capture and printing of an image of the remote subscriber at designated times. The images would be presented to the local subscriber after conclusion of the visual conference. The only images made would be given to the correspondent and it is contemplated that no copy or computer file of the image would be retained by control station 38. If in addition to receiving a copy of a captured image of the remote correspondent, the subscriber would like to send a copy of the captured image by e-mail to another person in the subscriber database, such as a sister, uncle, cousin, or friend, the subscriber would so notify the local technician of the names of the intended recipients and the local technician would also direct central processing unit 26 to send the captured image or images to each of the intended recipients without creating a file of the captured images in the computer's memory. Should a subscriber desire a videotape of his or her remotely located correspondent during the visual conference, the subscriber desiring the videotape could also send an audio or visual signal to the local technician for the local technician to direct central processing unit 26 to initiate image capture in videotape form of the remote correspondent for delivery to the local subscriber after conclusion of the visual conference, before the subscriber leaves control station 38. Privacy booths 2 can also be used for communication with customer service representatives, so that personal financial and other information revealed to them to obtain loans, open accounts, purchase insurance, or purchase stocks, and the like, will not be overheard by others. If the customer service personnel are in the same or a nearby building, pneumatic tube system 102 can be used by the subscriber and the customer service personnel to exchange written information.

Should money transfer be desired between correspondents, the sending subscriber would visually identify the amount of money the recipient is to receive in front of camera 10 in view of the local technician, the remote technician, and the recipient. Thereafter the sending subscriber while in front of camera 10 would place the identified amount of money into the hands of the local technician, so that the remote technician and the recipient can observe the transfer being made. Thereafter the recipient's local technician in front of the camera 10 in the recipient's privacy booth 2, so as to be visible by the sending subscriber and the sending subscriber's local technician, would place the identified sum via cash/check/bank voucher into the hands of the recipient, individually counting out the currency for the recipient if a cash transaction was made. Before leaving his or her local privacy booth 2 the recipient would sign a paper (not shown) acknowledging receipt of the transferred sum and hand the receipt to his or her local technician. It is contemplated for large sums to be transferred in the form of a check or bank voucher so that control station 38 is not made a target of theft, vandalism, or extortion. If the money transfer was made to the recipient by bank voucher, the recipient's local technician would direct central processing unit 26 to capture and send an image of the recipient by fax or computer to a local bank for confirmation of the identity of recipient when he or she arrives at the bank to claim the transferred sum, thus greatly reducing the possibility of the fraudulent claiming of such sum by anyone other than recipient.

Central processing unit 26 would maintain visual communication between corresponding subscribers after money transfer, until subscribers each exit their privacy booths 2 and notify their local technicians that the visual conference is concluded so that the local technicians can each then direct the local central processing units 26 to terminate their website connections. Subscribers could then schedule additional visual conferences, check e-mail messages sent to their assigned e-mail addresses through a nearby e-mail station 22, or send written e-mail messages to other people in the subscriber database through the local technician at control station 38 or through a nearby ATM station/KIOSK 62 or 82. When all of the communication activity of the subscriber is concluded, the subscriber would then leave control station 38. When all subscribers have left control station 38, if the central processing unit 26 at control station 38 is networked with central processing units 26 at remote ATM stations/KIOSKS 62 or 82, the local technician would direct the central processing unit 26 at control station 38 to enter an inactive mode from which it can be rapidly returned to active status by subscribers at remote ATM stationsKIOSKS 62 or 82 upon demand, or from personal computers and personal electronic devices (not shown), who enter their assigned unique access codes on keypad 68 and cause the central processing unit 26 at control station 38 to direct scanner 86 to scan one or more recorded messages, access the subscriber database to find the e-mail address of each identified recipient subscriber, and send the messages to the proper e-mail addresses, or by subscribers at remote e-mail stations 62 or 82, as well as from personal computers and personal electronic devices (not shown), who direct central processing unit 26 to retrieve mail from their e-mail address after which printer 18 prints a copy of each e-mail message for the accessing subscriber, or in the alternative prints a statement for the subscriber that no new messages had been received.

It is therefore contemplated for the present invention to include a wide variety of communication and financial transactions, including transactions that are consumer-to-consumer, consumer-to-business, business-to-consumer, business-to-employees, employee-to-business, business-to-business, business-to-government, consumer-to-government, government-to-business, and government-to-consumer. Also, in addition to the applications provided above, it is also considered to be within the scope of the present invention for recurring bills that have bar codes, such as those for utilities, credit card payments, mortgage payments, and department store purchases, to be paid using the network website and e-mailATM stations 22, 62, and 82, or a personal computer or personal electronic device incorporating scanning technology, whereby all that the subscriber must do is place the bills one by one through the scanner, after which network computer will recognize the bar code on each bill or invoice and pay all or part of the amount due at the subscriber's direction. Although a letter and check could be generated for mailing by the subscriber, it is preferred that any payment be made by electronically forwarding the funds to the creditor. The network could provide a form for use by subscribers unskilled in computer operation, and which could be easily read by OCR technology, through which the unskilled subscriber could give the computer instructions about bill payment. Another application is for a subscriber to conduct on-line shopping via the network website, and then pick up packages through one of network control stations. Also, if someone were lost while traveling, he or she could find a hotel lobby or restaurant with a remote e-mail/ATM station 62 or 82, and obtain written or oral directions to the intended destination. Should someone be ahead of schedule on a trip and decide to visit an additional museum, tickets could be purchased through the network website so that when the travelers arrive at the museum they will not have to waste time standing in a ticket line. Any monitor 12 or screen 68 could be a touch screen or digital screen with screensaver icons that would be available for purchase so that banks and mortgage companies could advertise loan and other account services, real estate offices could show virtual tours of houses, motels and resorts could show resort or vacation package deals through full motion video. Travelers could also periodically transfer money to smart cards for micropayments, such as the amount needed for a drink, snack, or to make a phone call. The smart card used can be the same one having the user's personal identity information required for access to the present invention system. Further international voice mail can eliminate expensive collect calls, whereby a scanned or written message can be delivered by the network to any designated voice mail box world wide, so that the sender does not have to repeatedly call in attempts to find the person at home. Further, cashier services in convenience stores could be made safer with variations of the remote email/ATM stations 62 or 82 of the present invention. The bar codes on purchased goods could be read by scanning technology, with no cash exchanging hands between customer and store clerk. The clerk's presence would only be required for making certain that all items are properly scanned prior to the conclusion of a purchase transaction. As an added layer of security protection for both store and subscriber, the purchaser's photo would be taken at the time of purchase. Money transfer via a personal computer or other electronic device into a college student's bank account or debit card account, or sending cash that can be picked up at a control station or remote ATM station/KIOSK, can be accomplished through the network website of the present invention from home, the office, or while on vacation. The parent is benefited by a less expensive transfer, while the student received the benefit of quick receipt of funds. Although the network will charge a fee for transactions, the network will give subscribers less expensive options to conduct many types of telecommunication and financial transactions, with many of the transactions being accomplished in a much timelier manner.

The privacy booths 2 and virtual bank teller units 22′ used as a part of the present invention can also offer advertisements before, during, and after a visual communication transmission. Advertisements can be for such products and services as credit cards, insurance, real estate transactions, securing credit to acquire a house or cars, financial services, and promotional trip packages. Also, information can be obtained through privacy booths 2 and virtual bank teller units 22′, as well as from any computer or device used to gain access to the present invention web site, about any affiliate company associated with the present invention network. Similarly, users of the present invention will have the opportunity to open a banking account in any affiliate financial institution that is a part of the present invention network. Job interviews with affiliate companies can also take place through use of privacy booths 2 and virtual bank teller units 22′, as well as private conferences with notable people in politics, television, the theater, cinema, and music. In the alternative, any computer or device used to gain access to the present invention web site may be alternatively used for the same purpose.

One comprehensive embodiment of the present invention system has the twenty-four diversified services outlined below to encourage client use and generate income, such as virtual account service which permits client or recipient access to transferred money without removing it from the system, bill payment, opening new accounts, and purchasing pre-paid cards. However, the present invention system is easily adaptable to provide additional communication or financial transaction services that may be desired to maintain or broaden a client base.

1. E-Mail Financial Transactions

The benefit of e-mail financial transactions is that it provides a fast, easy, and safe way to send money, with the option of sender and receiver being provided with prompt e-mail money transfer notifications.

2. Virtual Financial Transactions (Piggy Bank)

The benefit offered by the virtual financial transactions service is that the client has the option to create a temporary account for use with a single money transfer, or to create a virtual account of indefinite duration into which money can be deposited and maintained, and which can be managed as long as needed, in conjunction with nearly all of the other services available in the present invention system.

3. Money Wiring Transaction

It provides versatility for clients by allowing those receiving transferred money to pick it up at any ATM/KIOSK that subscribes to the present invention system. Similarly, money can be transferred to a designated recipient or recipient account from any ATM/KIOSK using the present invention system, or it can be transferred from any computer having Internet access. Sender and receiver notification of money transfer and receipt can be achieved by a variety of means, to include but not be limited to immediate visual confirmation via real-time video, e-mail message, pager notification, and computer-generated voice mail message forwarded to a cell phone or answering service/machine.

4. Paybills

This service can be accessed by clients from any computer or ATM/KIOSK, with the option of clients paying monthly bills manually or via automatic deduction according to payment terms specified in advance by the client. Payments can be made using a variety of client resources and/or accounts, including a present invention system virtual account, credit card, debit card, and/or savings account. The client can also request automatic present invention system notification when payments have been made via automatic deduction.

5. Prepaid Phone Cards

The advantage of this service is that it can be accessed from any computer or ATM/KIOSK to automatically introduce a user-selected credit balance to the client's own telephone account or that of another, such as a family member. The ATM/KIOSKS will also print new prepaid phone cards for the purchaser or a remote recipient, with the purchaser-selected credit balance being stored in a temporary virtual account until the remote recipient completes the transaction by approaching any convenient ATM/KIOSK using the present invention system and requesting it to issue a phone card. The remote recipient may transfer as much of the purchaser-selected credit balance to the phone card as desired, with any balance remaining in the temporary virtual account until finally used.

6. Prepaid Smart Debit Cards

This service can also be accessed from any computer or ATM/KIOSK. In a manner similar to that described above for the issuance of a phone card, it can automatically introduce a new credit amount to an existing debit card of the client or remote person. Through use of the present invention system, the ATM/KIOSK is also capable of issuing new debit cards.

7. Email Payroll

The benefit of E-mail Payroll is that it is a fast, efficient, and secure means of paying employees, and provides prompt notifications to both employers and employees. The employees can designate a preferred manner in which to receive notification that money is transferred to them, and when the employees access the transferred money, transaction completion notification is sent to the employer. The employees can then take advantage of the other twenty-three services within the present invention system, such as use of the virtual account to manage money, bill payment, or the purchase of prepaid cards, without having to take the time to first transfer the received money to other accounts. Money management can be accomplished solely within the present invention system.

8. Cashing Checks

The advantage provided by the present invention system in regard to cashing checks is the low fee that can be charged to cash it. This will draw clients to use the ATM/KIOSKS for this purpose, who will then take advantage of the other twenty-three services within the present invention system, such as use of the virtual account to manage money, bill payment, or the purchase of prepaid cards.

9. Money Orders

The advantage provided by the present invention system for the purchase of Money Orders is that the person sending it can obtain a notification that identifies the date that the Money Order is received and/or cashed.

10. Plane Tickets

The advantage provided by the present invention system for the purchase of an airline ticket is that the purchaser subsequently can obtain notifications and confirmations regarding departure date, delays, and/or cancellations.

11. Bus Tickets

The advantage provided by the present invention system for the purchase of bus tickets is that the purchaser subsequently can obtain notifications and confirmations regarding departure date, delays, and/or cancellations.

12. Entertainment Tickets

The advantage provided by the present invention system for the purchase of entertainment tickets is that the purchaser can obtain notifications and confirmations regarding changes in time, postponements, and/or cancellations. They can also obtain advance notification about events.

13. International and National Web-Voice Mail

The advantage of this service is that the client can obtain a telephone number and a voice mail box within the present invention system that will handle incoming calls, e-mail's, and Web-voice mail, with the option to block designated calls and/or to direct all or part of the incoming calls to a designated telephone number.

14. Prepaid Internet Access

The advantage of buying Prepaid Internet Access through the present invention system is that clients will be using the purchased service only when they are connected to the Internet.

15. Prepaid Software Applications & Games

The advantage of buying Prepaid Software Applications and Games through the present invention system is that clients will be using the purchased service only when they are connected to the Internet.

16. Customer Service in Voice & Full Motion Video

The present invention system will provide clients with round-the-clock multi-lingual customer service (English & Spanish at a minimum) and full motion video teller service for financial transactions.

17. Advertising in Full Video Motions

The present invention system will provide full video motion for the promotion of products, events, and services relating to the present invention and affiliated organizations or groups. However, the full video motion publicity can be used for any other purpose considered appropriate to the present invention system and its clients, such as safety and public information related messages.

18. Web Folder

The present invention system also can provide clients with a web folder space within which the client can organize his or her record keeping. The client can personalize each Web folder to his convenience, such as for the maintenance of virtual accounts, receipts payments, accounting record keeping, and the organization of personal and/or business information.

19. Virtual Digital Payments

The present invention system will provide virtual teller service that has digital screens through which the client will have the option to choose the type of payment that will be made, and/or establish a preference for completion of a transaction via a virtual account within the present invention system, a credit card account, a debit card account, a checking or savings account, or via cash.

20. Certify E-Mail Services

The benefit of the certified email services provided by the present invention system is that clients will have the security of knowing that the person who receives e-mail from them, and/or any money transferred with it, will have to submit to an identity check via visual, digital voice, and/or finger print technology before accessing the communication or transferred funds. The sender can also request for the present invention system to send him or her a confirming notification that the e-mail and/or transferred funds were received.

21. Sending and Receiving Scanned Documents

The benefit provided by the present invention system for this service is that clients can scan any document or picture without it being permanently recorded anywhere, and send it from any computer or ATM/KIOSK by e-mail to any part of the world for a low fee. It provides another diversification of services to attract and maintain a broad client base.

22. Web Voice Notification

The advantage of the Web Voice Notification is that it can be accessed from any website, telephone, personal digital assistant, or ATM/KIOSK. Through the Web Voice Notification service, clients can send or elect to receive any type of notification, such as but not limited to confirmation of financial transactions, family events, business transactions, and/or package deliveries.

23. Video E-Mail

The benefit of the video email provided by the present invention system is that the client can use it from any computer or ATM/KIOSK to send and/or receive family messages, business communication, and other personal transactions that may or may not include money messages.

24. Wireless Memory Space

The benefit of wireless memory space provided by the present invention system is that the client is able to save images, documents, and/or videos, by unloading digital memory space from any equipment, either manually or via wireless technology, to a personal folder within the Present invention system.

In addition, E-mail payroll is another option with the present invention system. It provides a fast, efficient, and secure means of paying employees, and provides prompt notifications to both employers and employees. The employees can designate a preferred manner in which to receive notification that money is transferred to them, and when the employees access the transferred money, transaction completion notification is sent to the employer. The employees can then take advantage of the other services within the present invention system, such as use of the virtual account to manage money, bill payment, or the purchase of prepaid cards, without having to take the time to first transfer the received money to other accounts. Money management can be accomplished solely within the present invention system.

The present invention system also can provide clients with a web folder space within which the client can organize his or her record keeping. The client can personalize each Web folder to his convenience, such as for the maintenance of virtual accounts, receipts payments, accounting record keeping, and the organization of personal and/or business information. In addition, the wireless memory space provided by the present invention system allows the client to save images, documents, and/or videos, by unloading digital memory space from any equipment, either manually or via wireless technology, to a personal folder within the present invention system. It can handle large files too big for processing and storage on some personal computers, and which when stored on a personal computer would slow its operation.

Prior to first use, each person desiring access to the present invention system must create a user profile through the following Smart Card registration process. During registration, a person desiring present invention services has the option of using the ATM/KIOSK'S telephone for customer service assistance through the Smart Card process. As a part of the registration process for membership activation, the system will require personal information from the user, such as the user's name, social security number, age, gender, voice pattern, fingerprint and a biometric picture. The user profile generated will be saved in the present invention system database. The profile will be provided to the new member in the form of a Smart Card with an imprinted member's picture on it issued by the system. In addition to the Smart Card, new members will receive an e-mail address and a password that in combination with the Smart Card provides faster and more secure member identification. At the user's option, a Virtual Financial Account can also be created and a copy of the membership information provided can be printed for his or her personal records. The Smart Card can be used as a rapid process of identification in the present invention System, as well as a debit or credit card of his/her Virtual Account to pay transactions in an affiliate ATM/Kiosk network.

To send money using the present invention requires several steps of identification. To receive present invention services, users must first be identified by the present invention system database. This is typically accomplished by the user introducing his or her member Smart Card and system-assigned password, in combination with one or more of the following: voice pattern, finger print, or biometric measurement or picture. Then the following procedures can be accomplished.

1. For money transfer via present invention or affiliate ATM/Kiosk units, the sender may optionally call Customer Service by using the ATM/Kiosk's telephone and provide the needed transaction information, such as identification of sender and receivers, and the total amount of each desired money transfer. A digital screen will inform the sender during the transaction process, verifying to the sender that the information provided is correct. The sender can select from a variety of receiver notification options, to include: e-mail, video e-mail, mobile phone, pager, or the receiver's home phone number with an option for the sender to customize a message for the receiver. Subsequently, the sender will choose a method of payment, selected from: Debit or Credit Card, personal bank account, cash, personal check, Money Order, or the user's previously established Virtual Financial Account inside the Present invention system. At the end of the transaction, a receipt will be printed for the sender that at a minimum includes the date, the amount of each money transfer, the receiver's name, and a transfer control number.

2. To send money via present invention or affiliate digital ATM/Kiosk units, the sender will use a digital screen and select the ‘send money’ icon. Using the transaction form provided to expedite the data entry process, the sender will fill in name of the sender and receiver, other pertinent information, and total amount of money intended for transfer to the receiver. The sender can choose any of the following receiver notification options of: e-mail, video e-mail, mobile phone, pager, or the receiver's home phone number with an option for the sender to customize a message to the receiver. Subsequently, the sender will choose a method of payment, selected from: Debit or Credit Card, personal bank account, cash, personal check, Money Order, or the user's previously established Virtual Financial Account inside the Present invention system. A copy of the transfer with a transfer control number will be printed in the form of a receipt at the end of the transaction.

3. For money transfer via the present invention website, the sender will be able to use any remote computer or device adapted to gain access to the Internet to initiate desired money transfer services. By choosing the “send money” option, the sender can fill in the transaction form with sender and receiver information and total amount of the transaction, with an option to call Customer Service for assistance. Receiver notification options include: e-mail, video e-mail, mobile phone, pager, or the receiver's home phone number with the option for the sender to customize a message for the receiver. Payment options include: Debit or Credit Card, personal bank account, personal check, Money Order, or the user's Virtual Financial Account inside the present invention system. Cash payments will be accepted by present invention affiliates. A copy of the transaction with a transfer control number will be printed as a receipt at the end of the transaction. If the user is not a member, the same user identification steps described above would be initially followed, resulting in an increased transaction time.

To receive money using the present invention requires several steps of identification. When sender activated, the present invention system automatically notifies a receiver that money has been sent. The notification could arrive through e-mail, video e-mail, mobile phone, pager, or in the form of a customized message from the sender directed to a home telephone. The receiver can claim the transferred money by going to any of the present invention affiliates, a present invention or affiliate ATM/Kiosk, Currency Exchange, Financial Institution, Credit Union, or through use of a personal computer or other electronic device adapted for Internet access. The receiver's identity is confirmed by introduction of a member Smart Card and system-assigned password, combined with voice pattern, fingerprint, and/or biometric picture that is compared to a previously established profile in the present invention data system.

1. To receive money via present invention or affiliate ATM/Kiosk units, the receiver may optionally call Customer Service by using the ATM/Kiosk's telephone, and provide the needed identity information, as well as information as to how the money transfer will be completed. A digital screen will inform the receiver during the transaction process, verifying that provided information is correct. The receiver can choose to notify the sender through the following options: e-mail, video e-mail, mobile phone, pager, or a customized message sent to the sender's home phone number. The method of money receipt can be selected from: Debit or Credit Card, personal bank account, cash, personal check, Money Order, or the receiver's previously established Virtual Financial Account inside the present invention system. A copy of the transfer will be printed as a receipt at the end of the transaction.

2. To receive money via present invention or affiliate Digital ATM/Kiosk units, the receiver will provide the needed identity information, and then use a digital screen to select the “cash money” icon, filling in any sender, receiver, or transaction information required by the system. The receiver can choose to notify the sender by any of the following notification options: e-mail, video e-mail, mobile phone, pager or a customized message sent to the sender's home phone number. The method of money receipt can be selected from: Debit or Credit Card, personal bank account, cash, personal check, Money Order or the receiver's previously established Virtual Financial Account inside the present invention system. A copy of the transfer will be printed as a receipt at the end of the transaction.

3. To receive a financial transfer via the present invention website, the receiver will be able to use any remote computer to access the present invention services. After identity confirmation and choosing the “cash money” icon, the receiver fills in any sender, receiver, or transaction information required by the system, with an option to call Customer Service for assistance. The receiver can choose to notify the sender by: e-mail, video e-mail, mobile phone, pager, or a customized message sent to the sender's home phone number. The method of money receipt can be selected from: Debit or Credit Card, personal bank account, personal check, Money Order, or the receiver's previously established Virtual Financial Account in the present invention system. Cash payments will be accepted on present invention affiliates. A copy of the transaction will be printed as a receipt at the end of the transaction. If the user is not a member, the same user identification steps described above would be initially followed, resulting in an increased transaction time.

What is claimed is:

1. A computer-aided telecommunication and financial transaction system between people remotely located from one another, that provides prompt and secure money transfer in addition to prompt and secure visual, written, and image communications, said system comprising:
an Internet website configured for visual and e-mail communication between people remotely located from one another;
at least one control station configured with computer-aided means for accomplishing visual and email telecommunication between people who are remotely located from one another and use said Internet website for sending and receiving visual and email messages without a permanent record of message content being maintained by said control station or on said website, said control station also being configured for accomplishing financial transactions between people who are remotely located from one another and use said Internet website for making financial transfers, sending and receiving money, and managing at least one virtual bank account within said system; and
a plurality of stand-alone automated teller machine kiosks in two-way electronic data communication with said at least one control station, each said kiosk having at least one central processing unit, means for automatic accepting and dispensing of money, at least one display monitor, at least one means of image capture, at least one means of providing data to said central processing unit, at least one means of audio capture, at least one means of audio transmission, at least one scanner, and at least one facsimile transmission machine.

2. The system of claim 1 wherein at least one of said kiosks further comprises features selected from a group consisting of telephone communication means, direct phone lines to customer service personnel, means for completing purchases and pre-payment for services, information gathering means, and web folder storage and management means.

3. The system of claim 1 further comprising at least one virtual bank teller having a digital television with touch screen menu options, a direct telephone line to customer assistance personnel, image capture means, audio capture means, audio transmission means, and pneumatic tube means adapted for transferring papers and other documents between a user and customer service personnel.

4. The system of claim 3 wherein said at least one virtual bank teller further comprises features selected from a group consisting of writing surfaces, customer service windows, and furniture adapted for seating users of said at least one virtual bank teller while they are conducting transactions.

5. The system of claim 1 wherein at least one of said kiosks is configured to prepare and transmit inventory information to said control station when cash reserves are low, and when cash reserves exceed a pre-determined level.

6. The system of claim 5 further comprising at least one of said kiosks is configured to transmit security breach information to said control station.

7. The system of claim 1 further comprising at least one smart card prepared and issued to repeat users of said system, each said smart card having identity information personal to said user and being required for user activation of said system.

8. The system of claim 7 wherein said identity information is selected from a group consisting of photos of user, biometric measurements of user, user voice prints, user fingerprints, digital images of user, family information, passwords, and encrypted information.

9. The system of claim 1 wherein at least one of said kiosks is configured to transmit video email messages.

10. The system of claim 1 wherein at least one of said kiosks is configured for user purchase of web memory space for data storage.

11. The system of claim 1 wherein at least one of said kiosks is configured for advertising in full motion video.

12. The system of claim 1 wherein at least one of said kiosks is configured for user purchase of web folder space through which user can organize personal and business records.

13. The system of claim 3 further comprising at least one personal computer adapted with image capture means for identity confirmation and communication with said at least one virtual bank teller.

14. The system of claim 7 wherein money can be added to said smart card for making micropayments.
